(19) United States
(12) Patent Application Publication
(10) Pub. No.: US 2026/0127619 A1
(43) Pub. Date: May 7, 2026

(54) GENERATING A POLLUTION EVENT REPORT

(71) Applicant: EMISSION SOLUTIONS LIMITED, London (GB)

(72) Inventors: Mark Wilson, Derby (GB); Freddie Talberg, London (GB)

(21) Appl. No.: 18/872,930

(22) PCT Filed: Jun. 9, 2023
(86) PCT No.: PCT/GB2023/051506

§ 371 Date: Dec. 9, 2024

(30) Foreign Application Priority Data
Jun. 9, 2022 (GB) 2208483.4

(51) Int. Cl. G06Q 30/018

(52) U.S. Cl. CPC G06Q 30/018

(57) ABSTRACT

The present disclosure provides a computer implemented method for generating a pollution event report. The method comprises: receiving pollutant data in respect of a pollutant measured at a site; determining, based on the pollutant data, that a pollution event has occurred at the site; receiving, based on the determination that a pollution event has occurred at the site, audio and/or image data captured at the site; and generating a pollution event report including an association between the pollution event and the audio and/or image data. A corresponding computer program, computer readable storage medium and system are also provided.

### TECHNICAL FIELD

The present invention relates to the field of pollution monitoring and management. In particular, the present invention provides methods and a system for generating a pollution event report in response to detecting a pollution event at a site.

### BACKGROUND

Many human activities create some form of pollution in the form of pollutants. For example, an industrial vehicle may emit noise as well as particulate and gaseous pollutants, such as carbon dioxide and nitrogen oxides (NOx). It may also emit light, which may be considered a form of pollution, particularly during the night.

Being able to monitor and manage the levels of pollution emitted from various sources is useful for a variety of reasons. One important need is that of monitoring for compliance with regulations or other pollution limits. For example, maximum allowable pollution levels may be set for a given region, e.g. a building site, or for a given piece of equipment, e.g. a lorry. In the case of a building site, there may be limits on the total noise emitted by the site at certain times of the day, for example. Meanwhile, in the case of a lorry, limits may be set on the amount of particulate matter and nitrogen dioxide emitted. These limits may be set by national or international legislation, local authorities, or may be voluntary as part of a certification scheme, for example.

In order to enforce these limits and ensure compliance or to manage and/or reduce pollution effectively even when compliant with current limits, it is important not just to be able to monitor pollution levels, but also to be able to identify the sources of the pollution so that the responsible party can be identified. This can ensure that appropriate action can be taken against any party in breach of the requirements. For example, a fine could be issued to a company that breaches emissions thresholds.

In the past, pollutions have been recorded and averaged over a longer period of time, such as over 15 minutes, 1 hour, 8 hours, and 24 hours, to allow a general assessment of the causes of the pollutions. However, these studies have been limited to providing input for general decision-making or legislation.

### SUMMARY OF INVENTION

The invention is defined in the independent claims. Optional features are set out in the dependent claims.

According to a first aspect of the invention, a computer implemented method for generating a pollution event report is provided. The method comprises: receiving pollutant data in respect of a pollutant measured at a site; determining, based on the pollutant data, that a pollution event has occurred at the site; receiving, based on the determination that a pollution event has occurred at the site, audio and/or image data captured at the site; and generating a pollution event report including an association between the pollution event and the audio and/or image data.

The received audio and/or image data comprises audio and/or image data captured at the site during the pollution event. Accordingly, the disclosed method involves the collation of associated audio and/or image data from a site in response to determining that a pollution event has occurred at the site. The combination of measured pollutant data mapped with associated audio and/or image data may improve pollution event diagnostics by providing an indication of the cause of pollution events to help mitigate the occurrence/severity of future pollution events.

Pollutant data may be received from at least one pollution sensor. The at least one pollution sensor may comprise one or more audio sensors, light sensors and/or emissions sensors. It will be appreciated that any sensor known in the art for detecting noise and/or pollutions may be used. Optionally, the pollutant data may be received from a plurality of pollution sensors. Optionally, the plurality of pollution sensors are distributed across at least two locations within the site. Optionally, the plurality of pollution sensors include two or more types of pollution sensor, each type of pollution sensor being configured to sense a different type of pollution.

Use of a plurality of pollution sensors can provide a number of advantages. It can allow pollution levels to be measured from a number of different locations. This can help track the spatial distribution of the pollution which can aid in correctly associating the measured pollution with the potential polluters that produced the pollution. Additionally or alternatively, different types of pollution can be measured. For example, both noise pollution and emission pollution could be measured and associated with a potential polluters.

A pollution event may be determined to have occurred when the pollutant is measured to have breached a threshold level. The threshold level can be used to give context to the pollution levels. It is often only of concern if pollution levels reach a certain point (e.g. a level considered dangerous or in breach of environmental regulations), and so a pollution event based on whether the measured pollutant exceeds a threshold level can advantageously be used as the basis for generating a pollution event report for notifying relevant parties and prompting appropriate mitigation actions.

Optionally, the threshold level may be based on one or more of the measured pollutant, the time of day, the day of the week, or the time in the year. The pollutant may comprise one or more of noise, light, carbon dioxide, carbon monoxide, one or more nitrous oxides, particulate matter. Optionally the particulate matter has diameters less than 10 μm, less than 4 μm, less than 2.5 μm, or less than 1 μm.

The selective use of different thresholds for different time periods may facilitate the monitoring of specific pollution compliance regimes and may account for varying pollutant levels across different time periods in order to identify trends/anomalies and compensate for ambient effects (e.g., a noise/emission pollution event thresholds may be set lower during the night). Different thresholds for different pollutants may reflect the different prevalence of pollutants in the atmosphere as well as the different health or environmental risks posed by different types of pollutant.

The method may optionally comprise obtaining a baseline level of the pollutant and the pollution event report may include a comparison of the baseline level of the pollutant with the measured pollutant level. The baseline level may be a historic average for a corresponding time period to the time at which the pollution event is determined to occur. Optionally, the corresponding time period may be one or more of a time of day, a day of the week, and a day of the month. The time period may be measured in seconds, minutes, hours or days, weeks, or months for example. The comparison of measured pollutant data with a pollutant baseline level may provide an indication of the severity of a pollution event based on the extent the measured pollution level differs from expected/nominal levels, which may improve identification and future mitigation of the more significant pollution events.

The pollution event may be determined to last for a predetermined duration starting from when the pollution event is initially determined to have occurred such that further pollution events based on the same pollutant cannot be determined within the predetermined duration. Optionally, the predetermined duration may be any one of 15 minutes, half an hour, one hour, or two hours. Optionally, the pollution event may retrospectively begin a predefined period before the pollution event is determined to have occurred. The predetermined duration may be any one of 15 minutes, half an hour, one hour, or two hours. Defining pollution events over a predetermined period of time may prevent an overload of pollution event identifications and importantly, prevent identification of multiple pollution events resulting from the same transient polluting activity because pollutants may exist in the atmosphere or environment for a longer period of time. Beginning the pollution event before it is determined to have occurred means that contextual information from the leadup to the pollution event is included in the report, thereby enabling the cause of the pollution event to be better identified.

The predetermined duration and/or the predefined period may be different for different pollutants. This may advantageously better reflect the nature of different pollutants. For example, emissions may take longer to build up or reach a sensor so a longer period is appropriate, whereas noise is more immediate so a shorter period may be appropriate.

The received audio and/or image data may include one or more of a photograph, a thermal image, an acoustic image, a video clip, and an audio clip. Different examples of possible audio and image data can be used alone or in combination to provide different information in the pollution event report, giving the user more information to use to assess the cause of a pollution event.

The audio and/or image data may be received from one or more audio devices and/or cameras. The one or more devices collecting the audio and/or image data may be different to the one or more devices collecting the pollutant data. If so, the one or more devices collecting the audio and/or image data may be at one or more different locations to the one or more devices collecting the pollutant data, or at the same location. Alternatively, one or more audio devices measuring noise pollution may also be used to collect audio data for the pollution event report.

The audio and/or image data may be captured in response to the determination that a pollution event has occurred. This may be advantageous from a privacy perspective as minimal data is captured, as well as from a computing resources perspective since the audio and/or image data is only captured in response to the identification of a pollution event rather than on a continuous basis, minimising power, memory and processing power used.

Alternatively, the audio and/or image data may be captured on a continuous basis and stored for a predetermined period of time after which it is deleted if no pollution event is determined to have occurred within the predetermined period of time. Optionally, the predetermined period of time may be one of 15 minutes, half an hour, or one hour. In particular, the predetermined period of time is preferably as long as, or longer, than the predefined period before which the pollution event is determined to have occurred, if such a predefined period is used. Such embodiments may be more resource intensive but can provide more context about a pollution event, in particular the lead up to a pollution event.

Optionally, the method may further comprise identifying, from the received audio and/or image data, one or more potential polluters. The identified one or more identified potential polluters may be included in the pollution event report. Optionally, the one or more potential polluters may include one or more vehicles, pieces of machinery, pieces of equipment, and people. The one or more potential polluters may be identified using one or more of image recognition, such as automatic number plate recognition, audio recognition, and artificial intelligence. Use of the captured audio or image data to automatically identify potential polluters in the generated pollution event report may help identify the cause of the pollution event.

The method further comprises sending, to a terminal, at least a portion of the pollution event report, the terminal being associated with a user associated with the site. A technical effect of doing this is to ensure that the relevant people are notified about the event so that it may be mitigated or appropriate information about the event captured.

Optionally, the method further comprises: prompting the user associated with the terminal to input, at the terminal, contextual information about the pollution event; receiving the contextual information from the terminal; and updating the pollution event report to include the contextual information. Use of the terminal to capture contextual information enables the likely cause of the pollution to be better identified, particularly for unusual or unexpected causes (and hence not easily determinable without contextual information).

Optionally, the terminal to which the at least a portion of the pollution event report is sent may be one of a predefined list of terminals associated with a predefined list of users associated with the site. Choosing a terminal associated with a specific user from a list in this manner (e.g., a list of site managers) ensures that the best person may be asked for contextual information.

Optionally, the terminal is selected from the predefined list of terminals such that it is a terminal associated with a user who is present at the site. Selecting the terminal associated with a user who is present at the site means that they will be able to provide both the most relevant contextual information as well as being the most likely to be in a position to act upon the pollution event to mitigate it. The user who is present at the site may be determined based on one or more of: facial recognition performed on images taken from the site; a predefined schedule of users at the site; an electronic logbook of users at the site; and a detection of a terminal that is associated with the user at the site.

Optionally, the terminal may be a mobile phone or device capable of receiving an SMS message, and wherein the at least a portion of the pollution event report is sent to the terminal as an SMS message. Use of SMS messaging may be a reliable method of transmitting the information from/to locations that may not have a strong mobile signal.

Optionally, the at least a portion of the pollution event report may comprise some or all of the received audio and/or image data. Including the audio or image data means that even if the user to which the pollution event report is sent is not present at the site they may still be able to provide relevant contextual information.

The method may further comprise receiving environmental data corresponding to a time associated with the pollution event. The environmental data may be included in the pollution event report. Including environmental data in the pollution event report may improve the determination of the cause of the pollution event as certain weather events may influence measured pollution levels.

Optionally, the method may further comprise determining whether the environmental data was likely to have contributed to the pollution event or not. The generated pollution event report may include the determination of whether the environmental data was likely to have contributed to the pollution event or not. Certain weather events may contribute to high measured pollution levels, leading to pollution events. Therefore, the inclusion of this information in the pollution event report may enable users to better determine the cause of the pollution event and assign appropriate responsibility.

The environmental data may comprise environmental data reflective of a geographical region within which the site is located. Optionally, the geographic region is an administrative region, a city, a borough, a county, a state, a post code area, or a ZIP code area. Consideration for environmental data associated with a broader region comprising the site location may help to differentiate between the “local” measured data and the broader environmental data which is not site specific.

Optionally, the environmental data may include weather data. The weather data optionally includes one or more of wind speed and/or direction, precipitation type and/or amount, air quality, humidity, ambient temperature, dust or particulate matter concentration.

Optionally, a mitigation action is determined based on the generated pollution event report. This provides an automatic suggested response to an identified pollution event. allowing an operator to easily take action when necessary. By only determining a mitigation action in response to an identified pollution event, the overall resources (e.g. computing power) needed by the system can be reduced.

Optionally, the mitigation action may be determined to reduce the measured pollutant to or below the threshold level. Determining a mitigation action such that it will reduce the measured pollutant to (or below) the threshold level means that an appropriate mitigation action is proposed that allows pollution levels to be brought back to acceptable levels (i.e. to or below the threshold).

Optionally, the mitigation action may be selected from a predetermined list of possible mitigation actions. Having a predetermined list of possible mitigation actions means that the mitigation action can be ensured to be relevant to the potential polluters that are being monitored and the particular use case of the method. For example, the predetermined list of mitigation actions can be determined based upon the type of location in which the method is being implemented (e.g. a building site), the expected potential polluters, and the like.

Optionally, the mitigation action comprises one or more of: adjusting a state of at least one potential polluters, adjusting a schedule of potential polluters'activity, providing instructions to an operator of at least one potential polluter to inspect and/or change the operation of at least one potential polluter. Optionally, the state of the at least one potential polluter may include on, off, idling, standby, low-power mode, and high-power mode.

Optionally, the method further comprises automatically implementing the mitigation action. Automatically implementing the mitigation action means that the system can be used to ensure that pollution levels stay below a desired level and that if they do reach or exceed this level then an appropriate action is automatically implemented to bring the pollution level back down to acceptable levels. This allows pollution levels to be automatically and effectively controlled.

According to a second aspect, there is provided a system comprising: a pollution sensor configured to collect pollutant data in respect of a pollutant at a site; an audio and/or image data sensor configured to capture audio and/or image data at the site; and one or more computers configured to perform the method of the first aspect.

According to a third aspect, a computer implemented method of monitoring pollution is provided. The method comprises receiving first pollutant data in respect of a pollutant measured at a first location and second pollutant data in respect of the pollutant measured at a second location; determining a first pollutant level based on the first pollutant level representing an amount of the pollutant at the first location and the second pollutant level representing an amount of the pollutant at the second location; comparing the first pollutant level and the second pollutant level; and displaying a visualisation of the first pollutant data and the second pollutant data. If the second pollutant level is above the first pollutant level then the second pollutant data is capped in the visualisation at the level indicated by the first pollutant data.

Monitoring pollution at two locations enables a comparison between the pollution levels at different locations to be made, which may improve diagnostics of the cause(s) of the pollution measured at one or both of the locations. For example, pollution measured at one location but not the other can likely be attributed to activity happening at the location the pollution was measured but not at the other location, whereas pollution measured at both can likely be attributed to environmental factors that affect both locations or to activity that is happening at both locations. If one location is taken as a reference location, used to give an indication of a local background level of pollution away from an area at which polluting activity is expected, and the other location is an area where polluting activity is expected, then comparing the two can give an indication of when polluting activity is occurring at the expected location (when the measured pollution is higher at the expected location). However, if the measured pollution at the reference location is higher, then this is likely an indication that pollution is rising for another reason that may not be related to the expected activity. Accordingly, capping the level at this location means that only pollution caused by activity at the expected location is recorded, not unrelated polluting activity at the reference location.

Optionally, the first pollutant data and the second pollutant data are collected by one or more sensors and received from the one or more sensors in substantially real time. Receiving the first and second pollutant data in real time gives an up-to-date view of the pollution levels, and means that the pollution data of interest, i.e. at the location at which polluting activity is expected to occur, is being compared to a currently determined baseline. This is advantageous compared to comparing to historical data or historical averages as it represents a live likely divergence from the background level and so can more accurately reflect when polluting activity is happening at a location.

Optionally, the first pollutant data and the second pollutant data are temporally synchronised. The ensures that pollution levels corresponding to the same time periods are compared.

Optionally, the method further comprises the step of determining that a pollution event has occurred at the first location. Determining that a pollution event has occurred may comprise determining that the first pollutant level is above a threshold level, for example.

Pollution events may correspond to peaks or spikes in pollution, and in particular may correspond to when the pollution reaches a certain level. Recording pollution events can give a history of periods where pollution is at a maximum and enable the activities that are most polluting to be determined and also for pollution mitigation strategies to be focused where most beneficial.

Optionally, the threshold level is based on at least one or more of the pollutant, the time of day, the day of the week, or the time in the year. Different thresholds for different times and/or dates enables more detailed compliance regimes to be monitored and takes into account the different effects of high pollutants at different times. For example, noise pollution may be considered a greater problem during the night and so have a lower threshold between the hours of 20:00 and 08:00 or some other “night time”period.

Optionally, if it is determined that a pollution event has occurred and it is determined that the second pollutant level is above the first pollutant level, a user can be alerted that the pollution event requires further investigation. This may be done through a pollution event report, as is generated according to the first aspect.

When the second pollutant level is above the first pollutant level, this can indicate that the source of the pollution is closer to the second location rather than the first location, which can mean that it is unlikely caused by the party implementing the pollution monitoring. Accordingly, it is beneficial to alert a user if a pollution event is registered but the pollution level is higher at the second location than the first location as it is likely that the pollution event was not caused by the party implementing the pollution monitoring but instead by a different party.

Optionally, the method may comprise discarding the pollution event if it is determined that the level of the pollutant at the first location is not above the level of the pollutant at the second location by a threshold amount.

This can be done in the case where, as described above, it is unlikely that the pollution leading to the pollution event was caused by the party implementing the pollution monitoring. This means that they will not have other's pollution attributed to them. Additionally, it enables efforts to mitigate pollution to be focused on pollution that can be mitigated by the party because it is caused by them, rather than by someone else over whom they have no control.

Optionally, the threshold amount is based on at least one or more of the pollutant, the time of day, the day of the week, or the time in the year. Having different thresholds for the amount that the first pollution data has to be above the second pollution data by in order for the pollution event to be discarded at different times and/or dates enables more detailed compliance regimes to be monitored and takes into account the different effects of high pollutants at different times. For example, noise pollution may be considered a greater problem during the night and so have a lower threshold between the hours of 20:00 and 08:00 or some other “night time”period.

Optionally, the pollution event lasts for a predetermined duration starting from when the pollution event is determined to have occurred. In this case, it may be that further pollution events based on the same pollutant cannot occur within the predetermined duration. Optionally, the pollution event retrospectively begins a predefined period before the pollution event is determined to have occurred. The predetermined duration may be 15 minutes, half an hour, one hour, or two. The predefined period may be 15 minutes, half an hour, one hour, or two hours. Beginning the pollution event a predefined period before it is determined to have occurred means that contextual information from the leadup to the pollution event is captured and included, for example, in a pollution event report, enabling the cause to be better identified.

Defining pollution events over a predetermined duration and/or a predefined period of time may prevent an overload of pollution event identifications and importantly, prevent identification of multiple pollution events resulting from the same transient polluting activity because pollutants may exist in the atmosphere or environment for an longer period of time. Beginning the pollution event before it is determined to have occurred means that contextual information from the leadup to the pollution event is captured and included, for example, in a pollution event report, thereby enabling the cause of the pollution event to be better identified.

The predetermined duration and/or the predefined period may be different for different pollutants. This may advantageously better reflect the nature of different pollutants. For example, emissions may take longer to build up or reach a sensor so a longer period is appropriate, whereas noise is more immediate so a shorter period may be appropriate.

Optionally, the visualisation of the first pollutant data and the second pollutant data comprises a visualisation of data collected during the predefined period. Visualising the pollution data in the predefined period prior to the point at which the pollution event was determined gives an indication as to how the pollution changed in the run up to the pollution event to give an insight into what may have caused it. For example, it can be seen if a build up of a pollutant in the atmosphere was gradual or sharp, which may correspond to different activity (i.e., an ongoing activity generating lower but continuous pollution or a transient activity generating a high level pollution over a short period of time).

Optionally, the visualisation of the first pollutant data and the second pollutant data comprises a visualisation of data collected during the predefined duration. Visualising the pollution data for the predefined duration after the point at which the pollution event was determined gives an indication as to how the pollution changes after the pollution event to give an insight into what may have caused it. For example, it can be seen if the level of the pollutant in the atmosphere remains high over a period of time or quickly decreases after the pollution event, which may correspond to different activity (i.e., an ongoing activity generating lower but continuous pollution or a transient activity generating a high level pollution over a short period of time).

Optionally, the visualisation of the first pollutant data and the second pollutant data comprises a graph of the measured amount of pollutant against time. A graph of the pollutant against time gives a clear and easy to comprehend visualisation of how the amount of the pollutant changes over time, and of the comparison between the first pollutant level and the second pollutant level.

Optionally, if the second pollutant level is the same as the first pollutant level then the second pollutant data is displayed preferentially over the first pollutant data.

Doing so makes it clear when the pollution at the first location exceeds that at the second location, and therefore may be above a reference level. Showing the second pollutant data preferentially highlights that the pollution level at the first location is no higher than the reference level. This maybe be particularly beneficial when the data is visualised as a line graph.

Optionally, the pollutant may be one or more of noise, light, carbon dioxide, carbon monoxide, one or more nitrous oxides, particulate matter; wherein optionally the particulate matter has diameters less than 1 μm, less than 2.5 μm, less than 4 μm, or less than 10 μm. Any combination of these pollutants or others may be measured, and the method may be applied to each measured pollutant.

Optionally, the first location is a location at which polluting activity to be monitored is expected to occur. The second location may be reference location at which polluting activity to be monitored is not expected to occur. The first location may be within a site at which pollution is to be monitored and the second location may be at an edge or outside of the site at which pollution is to be monitored. For example, examples of such sites may be construction or building sites; industrial areas or zones such as factories, waste processing plants; transport hubs such as stations, railyards, docks and shipyards; and the like. Having the first location in a site gives an indication of pollution at the site, and having the second location at the edge or outside of the site gives a baseline level to enable an estimation of the pollution caused by the site.

Optionally, the first location is at least 1 m, 5 m, 10 m or 20 m from the second location. Optionally, the first location is no more than 10 m, 20 m, 50 m, or 100 m from the second location. Having the first and second locations nearby but still separated provides a local, real time reference level which better reflects the local background pollution compared with a historical reference level or average for a large region. This can provide a better indication of when the pollution at the first location is actually due to activity at or near the first location, rather than other factors.

According to a fourth aspect, there is provided a system comprising: a first pollution sensor configured to collect pollutant data in respect of a pollutant at a first location; a second pollution sensor configured to collect pollutant data in respect of the pollutant at a second location; and one or more computers configured to perform the method of the third aspect. In some cases, the systems of the second and fourth aspects can be combined into the same system.

According to a fifth aspect of the invention, a computer program that, when executed on one or more computers, causes the one or more computers to perform the method of the first aspect and/or the third aspect is provided.

According to a sixth aspect of the invention, a computer readable storage medium having stored thereon the computer program of the fifth aspect is provided. For example, the computer readable storage medium may be a non-transitory computer readable storage medium.

According to any of the above aspects, disclosure if further provided of the following optional features:
Multiple wizards (i.e. guided user journeys) for different use-cases that guide a user through a set of questions to help them select the cause of a pollution spike and associate a label (tag) to the pollution spike. The wizard makes the selection of a label faster and more accurate because it limits the range of possible answers based on circumstances. The labels (tags) can be graphed to show the most frequent causes of specific pollutants (meaning an organisation can be guided as what cause they may wish to address first) and where possible, the supplier/vehicle/thing identified as most likely to have caused the pollution spike (providing a range of potential benefits such as assisting the user to spot potentially faulty vehicles or to suppliers who have a bad fleet or driver behaviours).

Provision is made for showing the proportion of the pollution level that is caused by activity at the site (the first sensor), by comparing it to a second sensor that is close, but far enough away from the activity. This is done by capping the second sensor reading so that it does not exceed the reading of the first sensor, and then subtracting the second sensor reading from the first sensor reading, to give the “difference”. The time and scale of the “difference” indicates the proportion of the pollution that is more likely to have been caused only by activity at site (i.e. that occurring near the first sensor). This has the benefit of indicating whether a pollution spike was caused by activities within the control of the site owner, and of equal benefit, when it was not within their control to prevent.

Where video is recorded at site, machine learning computer vision may optionally be applied to blur objects for which there is a privacy concern, namely people and vehicle numberplates. This allows video to be captured at the time of a pollution spike and then viewed by users, whilst taking steps to protect the privacy of individuals captured in the video. This provides the benefit of providing more context of what was happening at the time of the spike. It also avoids the limitations of an alternative approach (namely processing the image by computer and reporting only a list of objects detected and not uploading the video). This contributes to ensuring that the use of cameras for pollution management can implement privacy by design, and work to assist in compliance with the UK Data Protection Act, General Data Protection Regulation (GDPR) and other current and future regulations of a similar nature.

Provision is made for detecting and alerting to vehicle congestion at loading bays, car park queues, etc., by analysing (approximately) the number of vehicles seen by the camera using computer vision / machine learning techniques. Thus, it can be determined whether the number of vehicles exceeds a threshold, and where so as a consequence, an alert can be sent including the video. This has the potential benefit of alerting users to congestion early enough to minimize the pollution created by the idling of vehicles queueing as a result of congestion. Advantageously, this could be used to divert traffic to an alternate car park at a hospital site, for example.

### BRIEF DESCRIPTION OF THE DRAWINGS

The invention will be described with reference to the following figures. The same numerals will be used for the same feature throughout the figures where possible.

FIG. 1 is a flow chart of a method according to an embodiment of the invention.

FIG. 2 is a flow chart of a method according to a further embodiment of the invention.

FIG. 3 illustrates an exemplary implementation of an embodiment of the invention.

FIG. 4 is a flow chart of a method according to a further embodiment of the invention.

FIG. 5 illustrates a visualisation of pollution data in accordance with the invention.

FIG. 6 illustrates a computer-readable storage medium according to an embodiment of the invention.

### DETAILED DESCRIPTION OF THE INVENTION

The present invention relates to methods and systems for monitoring pollution, generating pollution event reports and managing the pollution levels. Herein, the term pollution may include energy pollution or contaminants output into the environment as a result of human activity. They may or may not be directly harmful to human, animal or environmental health or wellbeing. They may be in the form of chemicals or energy.

Examples of chemical pollutants include, but are not limited to, particulate matter, carbon dioxide, carbon monoxide and nitrogen oxides (NOx, including nitrogen oxide and nitrogen dioxide). Examples of energy pollution include noise pollution, heat pollution, vibrations and light pollution. Unless otherwise specified, the embodiments of the invention described below can be used with any form of pollution, or indeed with more than one type of pollution.

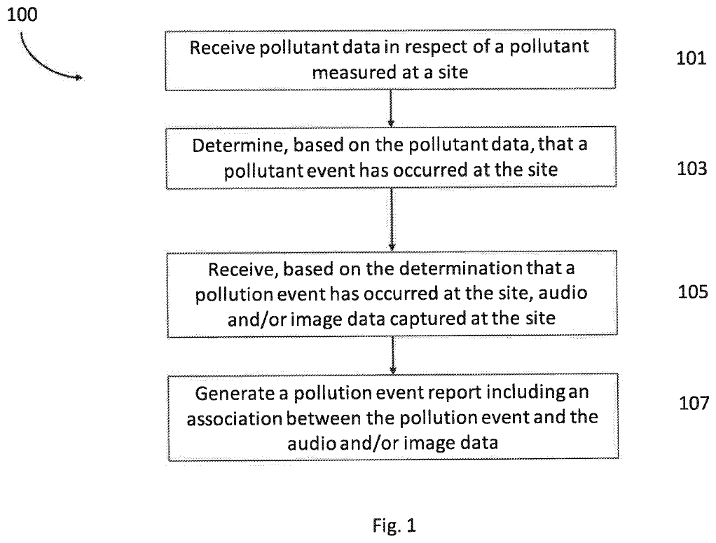

FIG. 1 shows a flow chart of a method 100 according to an embodiment of the invention. Method 100 comprises a computer-implemented method for generating a pollution event report.

Method 100 begins at step 101, which comprises receiving pollutant data relating to one or more measured pollutants at a site. The pollutant data is data measured using at least one pollution sensor configured to sense one or more pollutants. The pollutant data may be received from the at least one pollution sensor or from an intermediate source, such as a server configured to receive the pollutant data from pollution sensors.

At this step 101, pollutant data representative of one or more pollutant levels at or in the vicinity of a pollution sensor is received by the computer implementing method 100. The pollution sensor may be remote from the computer implementing the method or may be integral to it.

The pollutant data may be received from a single pollution sensor or from multiple pollution sensors, and may be received in any format suitable for machine processing by a computer. The pollution sensors may be operated by the same party that is performing the method described in FIG. 1, or the pollution sensors may be operated by a third party, who send (e.g. broadcast or transmit) the sensed pollutant data to the party implementing the method of FIG. 1.

The particular format used is not limited by this disclosure. The pollutant data should include, however, a timestamp or other indication of the time at which the pollutant data was captured. This may be included as metadata in the pollutant data itself. Alternatively, the computer implementing the method 100 could use the time at which the pollutant data is received as being representative of the time at which the pollutant data was captured. This may be done in particular when the pollution sensor is configured to provide its output directly to the computer, or arranged such that the computer receives the pollutant data in essentially real time. For example, the pollution sensor may be configured to communicate with the computer such as by one or more networks and one or more communication protocols. The pollutant data may be received continuously, periodically or at some irregular or otherwise determined time interval.

Pollutant levels may be determined from the pollutant data. The pollutant level is indicative of the amount of the pollutant present in the environment, and, for example, allows a comparison with other data or with benchmarks, targets, and thresholds. The form will depend upon the pollutant measured. For example, for light pollution the pollution level that is determined may be a brightness value, for noise it may be a sound intensity level (e.g. measured in decibels), and for gasses or particulates it may be a concentration value.

The next step 103 comprises determining, based on the received pollutant data, that a pollution event has occurred at the site.

A pollution event may be determined to have occurred if the received pollutant data indicates that a pollutant level has exceeded a threshold level. This is advantageous as it is often the case that there are restrictions and limits placed that provide a maximum allowable level of pollutant of a given type. Given that these are often legal limits, or limits imposed by an official authority (e.g. on a construction firm as part of planning permission), it is important to be able to determine when these levels are breached and additionally who is responsible for the breach such that appropriate action can be taken to reduce the pollutant levels to acceptable levels and to prevent future breaches.

The threshold level may be set based on the measured pollutant. For example, for light pollution the threshold level may be a brightness level, for noise it may be a sound intensity level (e.g. measured in decibels), and for gasses or particulates it may be a concentration level. In some cases, the threshold level may be based on one or more of the time of day, the day of the week, the time in the year. Selectively setting a threshold level based on time factors may ensure that appropriate threshold levels are chosen which account for nominal/expected pollution levels during the monitoring period.

Ensuring that appropriate threshold levels are chosen for specific pollutants over specific time periods improves the detection of outlier pollution events where pollution levels exceed expected levels. This may also reduce the number of identified false-positive pollution events and encourage a meaningful response to more serious pollution events.

The pollution event may be deemed to last a predetermined amount of time following the time at which the pollution event has been detected. This avoids detection of multiple pollution events resulting from the same pollutant.

The third step 105 of method 100 comprises receiving audio and/or image data captured at the site in response to determining that a pollution event has occurred at the site. The audio and/or image data may be received from one or more cameras and/or microphones located at the site or from an intermediate source, such as a server configured to receive the audio and/or image data from the camera and/or microphone.

The audio and/or image data may be received in any format suitable for machine processing by a computer. The camera and/or microphone may be operated by the same party that is performing the method described in FIG. 1, or the camera and/or microphone may be operated by a third party, who send (e.g. broadcast or transmit) the audio and/or image data to the party implementing the method of FIG. 1.

The received audio and/or image data comprises audio and/or image data captured during the detected pollution event. The audio and/or image data may comprise one or more of a photograph, a thermal image, an acoustic image, a video clip, or an audio clip. In some cases, the received audio and/or image data comprises audio and/or image data captured from a pre-determined during before the detected pollution event to a pre-determined duration after the detected pollution event. The audio and/or image data captured shortly before the detected pollution event can be helpful in determining the cause of the pollution event. For example, image data showing a vehicle entering the site shortly before a pollution event is detected may suggest that the arriving vehicle was responsible.

Step 107 of method 100 illustrated in FIG. 1 is the step of generating a pollution event report including an association between the pollution event and the audio and/or image data. The pollution event report therefore collates audio and/or image data associated with the site where the pollution event occurred to facilitate identification of the cause of the pollution event.

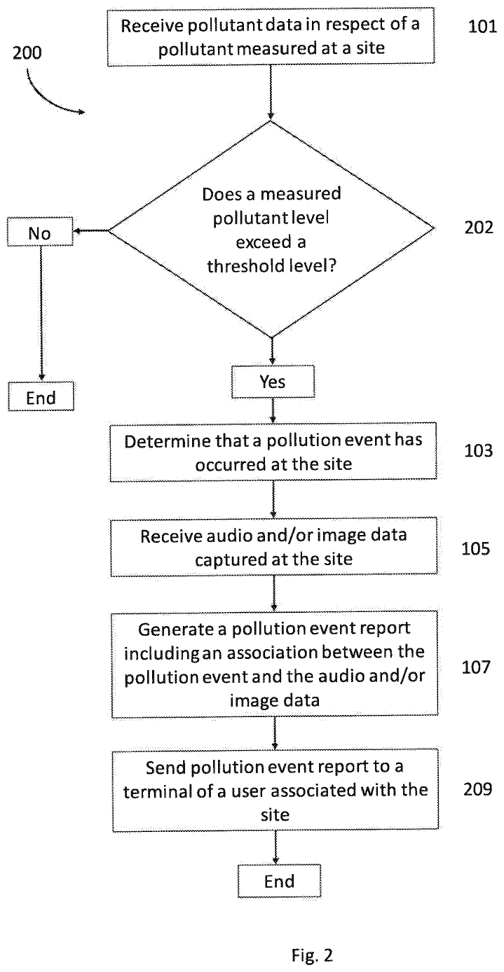

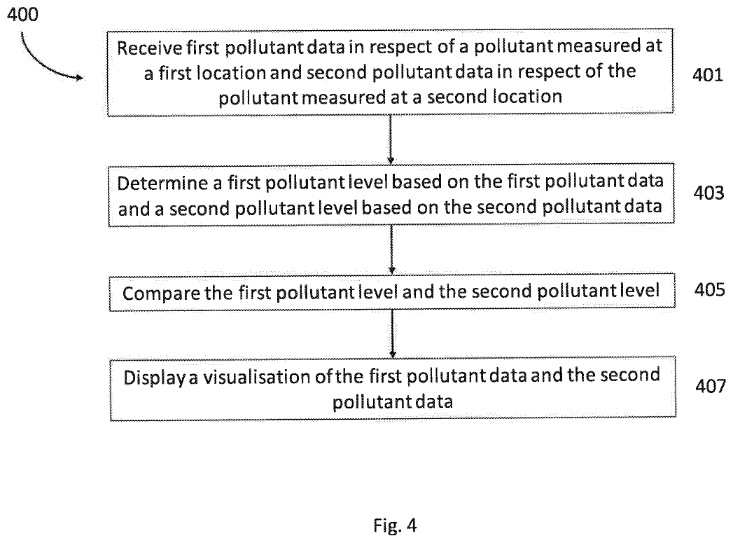

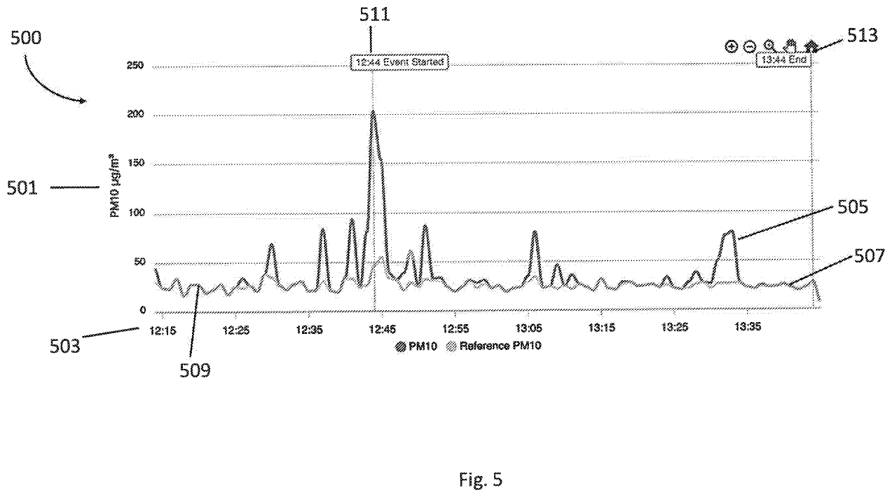

The pollution event report may comprise a baseline level of one or more pollutants and a comparison between the one or more measured pollutants and their respective baseline level. In some cases, the baseline level may represent a historic average for a corresponding time period at which the pollution event was determined to have occurred. The time period may relate to one of the time of day, the day of the week, the day of the month, or the time of year at which the pollution event was determined to have occurred. Further implementations of a baseline level comparison which may be used in conjunction with the method of FIG. 1 (and FIG. 2) are discussed below, in particular in relation to FIGS. 4 and 5.

The pollution event report may also identify one or more potential polluters based on the received audio and/or image data and the measured pollutant that triggered the pollution event. The one or more potential polluters may include one or more vehicles (which may include specific vehicles, types/models of vehicles, or vehicle characteristics such as fuel type), pieces of machinery, pieces of equipment or people.

The one or more potential polluters may be identified using one or more of image recognition (e.g., automatic numberplate recognition (ANPR)), audio recognition, or artificial intelligence on the received audio and/or image data.

Method 100 may further comprise receiving environmental data corresponding to the time of the pollution event. Accordingly, such environmental data may be provided as part of the pollution event report. In some cases, method 100 may further comprise determining whether the received environmental data was likely to have contributed to the pollution event or not, the determination being included within the generated pollution event report. This determination may be made based on information received from a database/look-up table mapping the effect of certain environmental conditions on detected pollutant levels.

The received environmental data may be reflective of a geographical region within which the site is located, which may include an administrative region, a city, a borough, a county, a state, a post code area or a zip code area. The received environmental data may include one or more of, wind speed, wind direction, precipitation type, precipitation amount, air quality, dust or particulate matter, temperature, or humidity.

For example, high wind speed may generally lead to lower amounts of measured of particulate or emissions pollution because the wind helps to dissipate the pollutants quickly, hindering their build up. On the other hand, high humidity and little wind tend to lead to higher amounts of measured particulate or emissions pollution because they enable the pollutants to stay in the atmosphere without dissipating for longer periods of time, enabling their build up. As will be appreciated, however, wind and humidity will have little or no effect on other types of pollution, such as light pollution. On the other hand, light pollution may be effected by atmospheric dust or particulate matter. Hence, different environmental and weather factors may have different effects on different pollutants, and this may be reflected appropriately in the pollution event report.

Another factor that can be taken into consideration is the type of pollutant measured. This can be particularly advantageous when multiple pollutant types are measured at similar times. For example, if two types of pollutant are measured, and two types of potential polluters are identified, the pollution of each type may be associated with one of the potential polluters based on a known relationship between the pollution produced by different potential polluters. This relationship may be obtained from a database. Advantageously, such a database can be created, or updated, based on associations made according to the method described herein, and optionally the method involves storing the associations between the received pollutant data and the identified potential polluters.

The method may further comprise determining, based on the information in the pollution event report, a mitigation action for reducing the pollution levels. The mitigation action may be determined based upon an association between the pollutant data and the one or more potential polluters.

The mitigation action is an action which will reduce the pollution levels at a location, such as a site, in the vicinity of the one or more pollution sensors. The mitigation action could be selected from a list of possible mitigation actions, with the selection being made based upon the association between the pollutant data and the potential polluters. That is, this association indicates what it is that is causing the pollution, and so an appropriate action can be determined that will reduce the pollution. For example, optionally it may be determined that a particular vehicle which is idling is producing emissions, and so the determined mitigation action may be to turn off the engine of that vehicle. In another example, if two loud machines are operating at the same time causing large levels of noise pollution, the determined mitigation action may be to operate the machines individually, one at a time. It is noted that, as will be apparent from these examples, further information may also be used to determine the mitigation action. The particular further information that is used will depend upon the specific implementation and the purpose for which it is being used, but possible examples of further information that could be used include schedules and timetables of movement of potential polluters, the state (e.g. on, off, idling) of potential polluters, hierarchies of potential polluters (e.g. an order of importance, or preferred order for turning off etc.), and so on. This list is not exhaustive. The mitigation action may also comprise multiple parts, i.e. it may not be one single action but may comprise a plurality of sub-actions. For example, it may comprise both turning off a potential polluter and adjusting a schedule.

The effect that a mitigation action will have on the pollutant levels may be known from a database, and so the appropriate mitigation action can be chosen from a list of mitigation actions stored in the database based on this. The effect of a mitigation action may also, or alternatively, be based, at least in part, on a prediction or model, and this may involve the use of machine learning and/or other artificial intelligence techniques. The mitigation action may be determined based upon further information beyond the association of the pollutant with the potential polluters, such as schedules and timetables of movement of potential polluters, the state (e.g. on, off, idling and so on) of potential polluters, hierarchies of potential polluters (e.g. an order of importance, or preferred order for turning off etc.), and so on. Similarly again, the mitigation action may also comprise multiple parts, i.e. it may not be one single action but may comprise a plurality of sub-actions.

As an example, the mitigation action may comprise one or more of: adjusting a state of the at least one potential polluters, adjusting a schedule of potential polluters activity, providing instructions to an operator of the at least one potential polluters to inspect and/or change the operation of the at least one potential polluters.

The instructions to an operator could be, for example, to inspect a particular potential polluters and rectify the cause of its excess emissions; to inspect a particular location to identify which particular potential polluter, amongst a number of co-located potential polluters, is the cause of increased pollution (for example, to determine the state of the potential polluters, which can then be input to determine an appropriate mitigation action to reduce the pollution levels); to inspect a particular location with a suggestion of the most likely potential polluters, amongst a number of co-located potential polluters, being the cause of increased pollution and to take appropriately determined action; to reschedule the regular presence of multiple potential polluters to avoid future excessive pollution from potential polluters at particular times (e.g. at specific times of day, days of the week etc.); and to adjust operating processes, such as changing the utilisation of potential polluters (e.g. using more electric rather than diesel vehicles) to reduce future occurrences of excess emissions.

Optionally, method 100 may conclude with the determined mitigation action being automatically implemented. For example, a schedule of when vehicles will arrive or when machines will be used could be automatically modified and updated, or a signal could be sent to cause a vehicle or machine to turn off or to instruct an operator to do so. Alternatively, the determined mitigation can be presented to a user or operator of a system implementing the method 100 or of a particular potential polluters (or indeed to other relevant persons) to inform them of the appropriate action to take.

FIG. 2 illustrates such a method 200 which includes the feature of determining whether the measured pollutant level exceeds a threshold level. It should be noted that the method of FIG. 2 encompasses that of FIG. 1, and that the discussion above in relation to FIG. 1 is equally applicable to the method illustrated in FIG. 2.

As with method 100 of FIG. 1, method 200 of FIG. 2 comprises step 101 of receiving pollutant data in respect of a pollutant measured at a site, step 103 of determining, based on the received pollutant data, that a pollution event has occurred at the site, step 105 receiving, in response to determining that a pollution event has occurred, audio and/or image data captured at the site, and step 107 generating a pollution event report including an association between the pollution event and the audio and/or image data. These steps are the same as those in FIG. 1, and so are not discussed again in relation to FIG. 2.

Additionally, the method 200 of FIG. 2 comprises step 202 of determining whether the at least one pollutant level exceeds a threshold level. At this step 202, the level of a measured pollutant determined from the pollutant data can be compared to a threshold level. The threshold level may not be a universal threshold, but may vary with time (e.g. a noise threshold may be higher during the day than at night), space (e.g. a noise threshold may be lower near residential buildings than near a factory), and may vary between different types of pollution (e.g. carbon dioxide may have a higher concentration threshold than nitrogen dioxide).

An example of thresholds that could be used is an average level of pollutions for a period of time, such as the average (e.g. mode, mean or other average) level measured over a day, week, etc. Additionally or alternatively, the threshold could be a certain factor of a reference level, for example 10% higher than the maximum value for the day before. The threshold could also be based upon other factors than just the pollutions level alone. For example, the number and/or types of potential polluters could also be taken into account-for the threshold to be breached both a certain level of pollution could be required in addition to a certain number of potential polluters, or a certain category or mix of potential polluters.

As discussed above, the threshold level may be set by various entities, such as governments, NGOs, local authorities, and operators of a system according to the invention, for example. This aspect is not limited by the present disclosure.

Additionally or alternatively to the mitigation action being determined if the pollutant level exceeds a threshold level, the mitigation action could be determined if a certain type of potential polluter is identified. For example, a mitigation action may be determined if a diesel vehicle is identified in a site that is reserved for electric vehicles. This may replace the determination of whether the pollutant level exceeds a threshold level at step 202, or may be carried out in addition to it.

Returning to FIG. 2, if, at step 202, the determined pollutant level is not found to exceed (i.e. breach) a threshold level, then the method 200 ends at step 202. In practice, this may mean that no further action is taken at this time, until further pollutant data is received, in which case the method 200 may then begin again at step 101.

On the other hand, if, at step 202, the determined pollutant levels are found to exceed the threshold level then at step 103 it is determined that a pollution event has occurred and the method 200 proceeds to step 103.

Additionally, method 200 of FIG. 2 comprises step 209 of sending the pollution event report to a terminal of a user associated with the site. The terminal may include one of a mobile phone or a computer associated with the user. The terminal may include any device capable of receiving an SMS message.

The receiving user may be a worker or manager responsible for operations on the site. In some cases the user may be selected from personnel known to be present on the site at the time when the pollution event was determined to have occurred. Information on personnel present on the site may be received from a database, for example an electronic logbook. Alternatively, personnel present on the site may be determined using facial recognition on received image data from the site.

Alternatively, rather than a user being identified as present at the site and then the appropriate terminal identified with them being determined, the terminals at a site can be directly determined. For example, this can be done through identifying terminals connected to a network, such as a site Wi-Fi (registered trademark) network, or through a sign in procedure carried out on, or at least in part using, the terminal. For example, many terminals are equipped with NFC capabilities which may be used at a turnstile or door to gain access to a site. At the same time as gaining access in this way, the fact that the terminal is present in the site can be recorded.

In some cases, the pollution event report may include a request for contextual information from the user of the terminal. The contextual information may include any information associated with the site which could explain the cause of the pollution event. The pollution event report may be updated based on contextual information received from the user of the terminal.

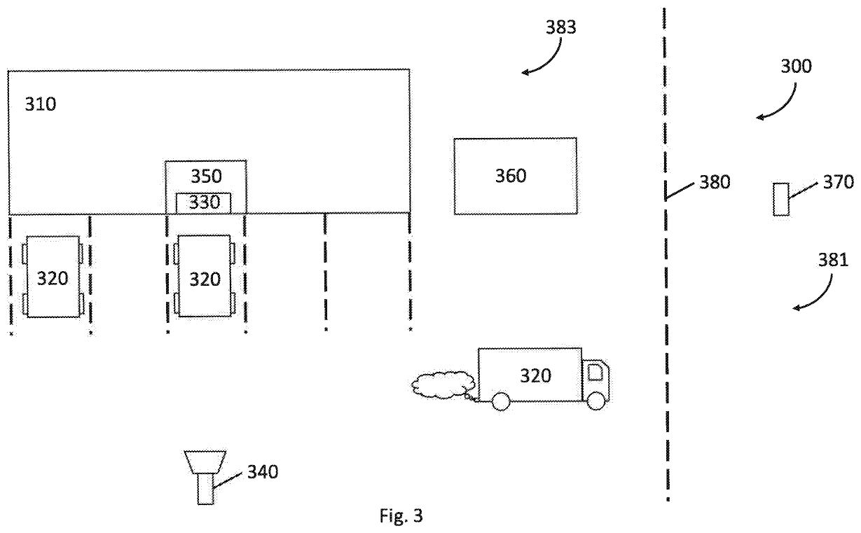

FIG. 3 illustrates a system 300 for implementing the above disclosed methods. In the illustrated embodiment, the site comprises a loading bay adjacent to a warehouse 310. It will however, be appreciated that in other embodiments, the site could be any location where it is desirable to monitor and/or manage pollution levels. The illustrated loading bay comprises several potential polluters 320 in the form of lorries.

System 300 comprises one or more pollution sensors 330, one or more audio and/or image data capture devices 340 and a controller 350 communicatively coupled to the one or more pollution sensors 330 and the one or more audio and/or image data capture devices 340. In some cases, pollution sensor 330 and/or audio and/or image devices 340 may be integral to controller 350.

Pollution sensor 330 is configured to sense/measure one or more pollutants. The particular details of pollution sensor 330 will depend upon the individual use case of the system 300, for example the type of pollution that is to be measured, the environment in which pollution sensor 330 is to be placed, the desired level of accuracy and the cost of different types of pollution sensor 330. The placement of pollution sensor 330 will also be dependent upon similar considerations. In some cases, it will be preferred for pollution sensor 330 to be placed close to potential polluters 320. For example, a NOx sensor may be placed nearby to a road or vehicle access point so that it will get a more accurate picture of the amount of pollutant emitted by vehicles that go past. On the other hand, a microphone may be placed away from a building site and nearby to residential buildings to give an indication of the amount of noise produced by the building site that is heard at the residential buildings.

Examples of types of pollution sensor 330 include microphones for sensing noise pollution, accelerometers for measuring vibration, and photoresistors or photodiodes for measuring light. The specific type of sensor used is not limited herein and may be any known sensor suitable for measuring the desired type of pollutions.

The audio and/or image data capture devices 340 may comprise one or more microphones or cameras of a variety of types. Similarly to pollution sensors 330, audio and/or image data capture devices 340 may be positioned relative to potential polluters 320 such that meaningful audio and/or image data may be captured. As shown in FIG. 3, the audio and/or image data capture device 340 is positioned to receive audio and/or image data from the loading bay outside warehouse 310.

Controller 350 is configured to initiate the steps of the above described methods, and may be an edge computer, for example. Specifically, controller 350 is configure to receive pollutant data measured by pollution sensor 330 and, based on the received data, determine whether a pollution event has occurred. Where a pollution event is determined to have occurred, controller 350 receives associated audio and/or image data collected by audio and/or image data capture device 340. Upon receiving the audio and/or image data, controller 350 is configured to generate a pollution event report by mapping the received the audio and/or image data to the detected pollution event. It will be appreciated that controller 350 need not be located at the site, so long as a communicative coupling exists to the pollution sensor 330 and the audio and/or image data capture device 340.

System 300 further comprises one or more terminals 360 communicatively coupled with controller 350 for receiving pollution event reports generated by controller 350. Terminal 360 is associated with a user of the loading bay. As illustrated in FIG. 3, terminal 360 is located in an office adjacent warehouse 310, though it will be appreciated that terminal 360 need not be static and may be a mobile terminal.

Terminal 360 may be a mobile phone, computer, or any device capable of receiving a pollution event report generated by controller 350. In some cases, multiple terminals 360 may be provided, each terminal 360 being associated with a different user on the site. In such cases, controller 350 may receive the location and/or status of each terminal 350 so that a generated pollution event report may be sent to an active terminal 360 located at the site. The controller 350 may be a computer, server or other computer system capable of performing the required processes and receiving and transmitting data as required by the method. The controller 350 need not be a single computing device, and instead may be a number of networked devices which may each perform parts of the method. In other cases, the controller 350 may be a distributed computer system.

FIG. 4 shows another method 400 according to aspects of the invention. The method 400 of FIG. 4 is a method of monitoring pollution, and in particular for monitoring pollution at a first location with respect to a second location.

Method 400 begins at step 401 with the receiving of first pollutant data and second pollutant data. The first pollutant data and the second pollutant data both relate to the same pollutant (e.g., noise, or light, and so on) but measured at different locations. The first pollutant data is in respect of the pollutant measured at a first location and the second pollutant data is in respect of the pollutant measured at a second location, the second location being different from the first location.

Step 403 of method 400 comprises determining a first pollutant level based on the first pollutant data and a second pollutant level based on the second pollutant data. The first pollutant level represents an amount of the pollutant at the first location, whereas the second pollutant level represents an amount of the pollutant at the second location.

At step 405, the first pollutant level and the second pollutant level are compared. That is, a comparison is made between the amount of the pollutant present at the first location and the amount of the pollutant present at the second location.

The results of the comparison at step 405 are then used in step 407, where a visualisation of the first pollutant data and the second pollutant data is displayed. In this visualisation, if the second pollutant level is above the first pollutant level, then the second pollutant data is capped at the level indicated by the first pollutant data.

Capping the second pollutant data at the level of the first pollutant data in the visualisation enables a clearer picture of the pollution caused by activity at the first location to be obtained. This is especially helpful when the first location is a location at which it is desired to monitor polluting activities (e.g., a site, such as a building or construction site) and the second location is at a location that is preferably nearby but where it is not expected that the polluting activities at the first location will cause (substantially) increased levels of pollution (e.g., outside the site). This means that the pollution measured at the second location can act as a local, real time reference level against which the pollution measured at the first location can be compared. This enables a more accurate determination of the amount of pollution caused by activity at the first location when compared with using other reference or baseline levels, such as an historic average for a location or a distant reference location that may not be representative of the background level of pollution in the locality of the first and second locations.

However, events may cause the level of the pollutant at the second location to temporarily spike or increase. Given that the second location should be away from the polluting activity being monitored, it can be concluded that such increases in the second pollutant level are not caused by activity at the first location and instead are due to unrelated activity (e.g., an unrelated vehicle passing by the second location causing an emissions rise, or a resident using power tools in their garden nearby to the second location causing an increase in noise). To avoid these polluting events being attributed to the activity at the first location, and to avoid pollution at the second location obscuring the important variation in pollution at the first location that is of interest, the second pollutant level is capped to the first pollutant level. This capping of the second pollutant data is illustrated in FIG. 5.

FIG. 5 illustrates a visualisation of the first pollutant data and the second pollutant data in the form of line graph 500. Line graph 500 has an amount of pollution on the x-axis 501, representing the level of the pollution determined from the pollutant data measured at the first and second locations. The y-axis 503 plots time. In the illustrated examples, the pollutant being measured is PM10 particulate matter, i.e., particulates with a diameter of less than 10 μm. This is measured as a density in the form of micrograms per cubic metre (μg/m³) on the x-axis 501, though other forms of pollutant may be measured with different units. Time is shown on a scale of 10 minute intervals on the on the y-axis 503. Data may be captured, however, at other intervals, however, such as continuously or near continuously, such as at 1 second intervals, 10 second intervals, and so on. In some cases, particularly when presented electronically, it may be possible to “zoom in” on smaller time ranges to view more detail.

Line graph 500 plots both the first pollutant level determined from the measured first pollutant data at the first location on line 505 (“PM10”) and the second pollutant level determined from the measured second pollutant data at the second location on line 507 (“Reference PM10”). It is preferred that both the first pollutant data and the second pollutant data are plotted on the same graph 500, but this need not necessarily be the case and in some instances separate graphs may be used.

It can be seen that at no point on the graph is line 507, representing the second pollutant level, above line 505, representing the first pollutant level. This is because, as discussed with respect to step 407 of FIG. 4, the second pollutant level is capped at the first pollutant level. In this case, the second pollutant level is preferably preferentially shown over the first pollutant level. This can be seen at location 509 on graph 500. Here, line 507 representing the second pollutant level is visible, but line 505 representing the first pollutant level is not. This is because, at this time (between about 12:15 and 12:25), the second pollutant data and the first pollutant data indicated that there was more of the pollutant at the second location than the first location. Accordingly, the second pollutant level is capped a the level of the first pollutant and so line 507 is at the same level as line 505. Line 507 is presented preferentially over line 505 as the second pollution level is presented preferentially over the first pollutant level as this helps to highlight when the first pollutant level diverges from the reference level represented by the second pollutant level.

On the other hand, when the first pollutant level is higher than the second pollutant level, this represents an increase in the pollution at the first location over the level of the pollutant at the second, reference location. Accordingly, this difference is likely to be attributable to polluting activity at the first location, the impact of which it is desired to assess. It is, therefore, beneficial to present both the first and the second pollutant levels when the first pollutant level is higher than the second pollutant level. For example, this occurs on graph 500 when pollution event 511 begins at 12:44. Here, it can be seen that line 505 rises to over 200 μg/m³, well above line 507 which peaks at a little over 50 μg/m³. It can, therefore, be seen that there is much more pollutant at the first location than the second location, indicating that the polluting activity at the first location is likely the cause of the pollution at the first location and so can be more effectively investigated and mitigated.

When the first pollutant reaches a threshold level, a pollution event 511 may be determined to have occurred. In the example illustrated in FIG. 5, the threshold level is 200 μg/m³ and so the pollution event 511 starts at 12:44. The pollution event 511 also lasts for a predetermined duration of one hour, finishing at 13:44 at 513. It will be appreciated that the pollution event can, in general, be defined and determined in accordance with the description in relation to FIGS. 1 and 2.

Whilst FIG. 5 illustrates a line graph 500 as visualising the first pollution data and the second pollution data, it will be understood that other types of data visualisation may be used instead or in addition. In particular, the way in which the pollution data is visualised may be based on how the first and second pollution data is captured. For example, if the pollution data is captured on a continuous basis, then a line graph as illustrated may be appropriate. Alternatively, if the pollution data is captured at discrete intervals, then a bar graph may be appropriate. Other types of visualisation may be used in addition to or instead of graphical visualisations. For example, the first pollutant data and the second pollutant data may be presented in a table. In some cases, colour, shade, or intensity may be used to represent an amount of pollution instead of or in addition to other methods.

It will be appreciated, particularly in the case where a pollution event is determined based on the first pollutant data, that a pollution event report may be generated according to the methods described in relation to FIGS. 1 and 2 described above and that the visualisation (e.g., graph 500) may be included in this pollution event report.

Returning to FIG. 3, as well as being able to implement the method of FIGS. 1 and 2, system 300 can also implement the method 400 of FIG. 4 in addition to, or alternatively to, methods 100 and 200.

In FIG. 3, dashed line 380 represents a site boundary, with area 383 being within the site and area 381 being outside the site. The site is an area where pollution activity is expected to occur and where it is desired to monitor and potentially mitigate or reduce polluting activity. As previously noted, the site in FIG. 3 comprises a loading bay adjacent to a warehouse 310. It will, however, be appreciated that in other embodiments the site could be any location where it is desirable to monitor and/or manage pollution levels. The illustrated loading bay comprises several potential polluters 320 in the form of lorries.

A first pollution sensor 330 is configured to sense/measure one or more pollutants as described above, and is located at a first location that is within the site. In particular, it should be at a location where it would be able to detect pollution caused by polluting activities that it is desired to monitor. In this case, the first pollution sensor 330 is located proximate to the warehouse 310 by the loading bays.

A second pollution sensor 370 is also provided and is configured to sense/measure the same pollutant or pollutants as the first pollution sensor 330. However, the second pollution sensor 370 is located at a second location that is outside the site. Preferably, the second location is one where it is not expected that activity at the site will cause a significant rise in pollution levels. For example, it may be preferably not to locate the second sensor 370 along a main road which, although outside the site, may be a likely route for vehicles entering or exiting the site and so may not give an accurate background pollution reading representative of the level of pollution in the locality not caused by site (or site related) activity. The location of the second location may also depend on the type of pollutant being monitored. For example, if monitoring light pollution, whether the second pollution sensor has line of sight to activity within the site should be considered. This may not be such a large consideration, however, for other types of pollutant such as emissions or noise.

For example, the second location may be at least a certain distance form the first location, such as at least 1 m, 5 m, 10 m or 20 m from the first location, in order to ensure that it does not sense the pollution generated at the first location to a great extend. Additionally, or alternatively, the second location may be no more than a certain distance from the first location, such as no more than 10 m, 20 m, 50 m, or 100 m from the first location, in order that it reflects an appropriate local reference level.

The data collected by the first and second pollution sensors, that is, the first pollutant data and the second pollutant data, should be temporally synchronised and is preferably received at a computing system, such as controller 350, in substantially real time to be processed according to the method 400 described above.

Whilst only one first pollution sensor 340 and one second pollution sensor 370 are illustrated in FIG. 3, this should not be seen as limiting. For example, multiple first pollution sensors could be present at different locations around the site, and multiple second pollution sensors could be present at different locations outside the site. Alternatively, or in addition, multiple pollution sensors may be co-located at the first location and at the second location in order to monitor different types of pollution. For example, each location may have a microphone for sensing noise as well as a particulate sensor for sensing particulate pollutants.

If multiple first pollution sensors are present at different locations within the site that are configured to sense the same pollutant at different locations within the site, then these may each be treated independently and independently compared to the reference pollutant level measured at the second location. They could be visualised, for example, on a separate graph each. Alternatively, they could all be visualised on the same graph, and the second pollutant level may be capped at the level of the highest level sensed by one of the first pollutant sensors.

If multiple second pollution sensors are present at different locations, then they could be combined to give an overall local background level. For example, this could be done by averaging the pollution level at different second locations around the outside of the site. This may help to negate for local polluting activity near one or the second locations that is not caused by the party that wishes to monitor pollution at the site. Alternatively, the pollution data from each second pollutant sensor may be combined and may, for each time point, take the value of the maximum level detected by any of the second pollutant sensors.

It will be appreciated that these are simply intended to be examples of how the method and system may be implemented with multiple first and/or second pollutant sensors, and that other ways will be apparent to the person skilled in the art.

In some cases, if a pollution event is determined to have occurred but the level of the pollution at the second location is higher than the level of pollution at the first location, the pollution event can be discarded. Preferably, a threshold level is used such that if the second pollutant level is within or above the first pollutant level by a threshold amount then the pollution event is discarded. In other words, the pollution event may be discarded if it is determined that the level of the pollutant at the first location is not above the level of the pollutant at the second location by a threshold amount. The threshold amount is based on at least one or more of the pollutant, the time of day, the day of the week, or the time in the year, and may vary between different pollutants and different times, in accordance with the principles discussed previously herein.

Discarding pollution events in this manner may be beneficial because it is likely that the pollution event was not the result of polluting activity at the first location, but instead a result of external factors. Discarding may be done, in particular, when multiple second sensors are used as this may give a more accurate “background” reading for the pollution in the locality of the site and may therefore enable the pollution event to be attributed to an external factor (rather than polluting activity at the first location) with a relatively high degree of confidence. Discarding pollution events in this manner acts as a filter to automatically filter out apparent pollution events that are not the result of the polluting activity at the first location that is intended to be monitored.

The methods described herein are capable of wide application to many different situations and environments. For example, it is contemplated that such methods need not be confined to land-based implementations but may also include sea or airborne sensors to monitor and manage pollution due to shipping and aeroplanes, for example.

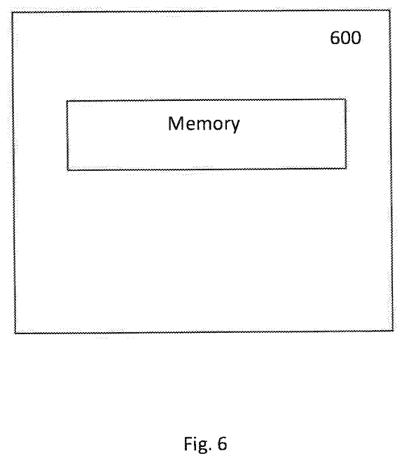

Furthermore, the method may be implemented on any suitable computer or computing system capable of carrying out the method and having the required programming thereon. This may be a single computer device having one or more processors, or a distributed computing system. For instance, FIG. 6 illustrates a computer-readable storage medium 600 having a memory comprising instructions, which when executed by a processor, cause the steps of the above described methods to be executed. In some instances, processing tasks may be performed by remotely and/or on cloud computing servers. It will be understood by the person skilled in the art that the present invention is not limited in this regard.

### CLAUSES

The following clauses form part of the description, and correspond to the claims as filed of the priority application (GB 2208483.4).
1. A computer implemented method of generating a pollution event report, the method comprising:
   receiving pollutant data in respect of a pollutant measured at a site;
   determining, based on the pollutant data, that a pollution event has occurred at the site;
   receiving, based on the determination that a pollution event has occurred at the site, audio and/or image data captured at the site; and
   generating a pollution event report including an association between the pollution event and the audio and/or image data.
2. The method of clause 1, wherein a pollution event is determined to have occurred when the pollutant is measured to have breached a threshold level.
3. The method of clause 2, wherein the threshold level is based on at least one or more of the pollutant, the time of day, the day of the week, or the time in the year.
4. The method of any preceding clause, wherein the pollutant may be one or more of noise, light, carbon dioxide, carbon monoxide, one or more nitrous oxides, particulate matter; wherein optionally the particulate matter has diameters less than 10 μm, less than 4 μm, less than 2.5 μm, or less than 1 μm.
5. The method of any of clauses 2 to 4, further comprising obtaining a baseline level of the pollutant; wherein the pollution event report includes a comparison of the baseline level of the pollutant with the measured pollutant level.
6. The method of clause 5, wherein the baseline level is a historic average for a corresponding time period to the time at which the pollution event is determined to occur; wherein optionally the corresponding time period is one or more of a time of day, a day of the week, and a day of the month.
7. The method of any preceding clause, wherein the pollution event lasts for a predetermined duration starting from when the pollution event is determined to have occurred; wherein further pollution events based on the same pollutant cannot occur within the predetermined duration; and wherein optionally the predetermined duration is 15 minutes, half an hour, one hour, or two hours.
8. The method of clause 7, wherein the pollution event retrospectively begins a predefined period before the pollution event is determined to have occurred; and wherein optionally the predetermined duration is 15 minutes, half an hour, one hour, or two hours.
9. The method of clause 7 or 8, wherein the predetermined duration and/or the predefined period is different for different pollutants.
10. The method of any preceding clause, wherein the audio and/or image data includes one or more of a photograph, a thermal image, an acoustic image, a video clip, and an audio clip; and/or
   wherein the audio and/or image data is captured in response to the determination that a pollution event has occurred.
11. The method of any of clauses 1 to 9, wherein the audio and/or image data is captured on a continuous basis and stored for a predetermined period of time after which it is deleted if no pollution event is determined to have occurred within the predetermined period of time; wherein optionally the predetermined period of time is 15 minutes, half an hour, or one hour.
12. The method of any preceding clause, comprising identifying, from the received audio and/or image data, one or more potential polluters;
   wherein the pollution event reports includes the one or more identified potential polluters; and
   wherein optionally the one or more potential polluters includes one or more vehicles, pieces of machinery, pieces of equipment, and people.
13. The method of clause 12, wherein the one or more potential polluters are identified using one or more of image recognition, such as automatic number plate recognition, audio recognition, and artificial intelligence.
14. The method of any preceding clause, further comprising:
   sending, to a terminal, at least a portion of the pollution event report, the terminal being associated with a user associated with the site.
15. The method of clause 14, further comprising:
   prompting the user associated with the terminal to input, at the terminal, contextual information about the pollution event;
   receiving the contextual information from the terminal; and
   updating the pollution event report to include the contextual information.
16. The method of clause 14 or 15 wherein the terminal to which the at least a portion of the pollution event report is sent is one of a predefined list of terminals associated with a predefined list of users associated with the site.
17. The method of clause 16, wherein the terminal is selected from the predefined list of terminals such that it is a terminal associated with a user who is present at the site;
   wherein optionally the user who is present at the site is determined based on one or more of: facial recognition performed on images taken from the site; a predefined schedule of users at the site; an electronic logbook of users at the site; and a detection of a terminal that is associated with the user at the site.
18. The method of any of clauses 14 to 17, wherein the terminal is a mobile phone or device capable of receiving an SMS message, and wherein the at least a portion of the pollution event report is sent to the terminal as an SMS message.
19. The method of any of clauses 14 to 18, wherein the at least a portion of the pollution event report comprises some or all of the audio and/or image data.
20. The method of any preceding clause, further comprising receiving environmental data corresponding to the time of the pollution event; wherein the pollution event report includes the environmental data; and
   wherein optionally the method further comprises determining whether the environmental data was likely to have contributed to the pollution event or not; wherein the pollution event report includes the determination of whether the environmental data was likely to have contributed to the pollution event or not.
21. The method of clause 20, wherein the environmental data is environmental data reflective of a geographical region within which the site is located; wherein optionally the geographic region is an administrative region, a city, a borough, a county, a state, a post code area, or a ZIP code area.
22. The method of clause 20 or 21, wherein the environmental data includes weather data; wherein optionally the weather data includes one or more of wind speed and/or direction, precipitation type and/or amount, air quality, dust or particulate matter concentration.
23. A computer program that, when executed on one or more computers, causes the one or more computers to perform the method of any of clauses 1 to 22.
24. A non-transitory computer readable storage medium having stored thereon the computer program of clause 23.
25. A system comprising:
   a pollution sensor configured to collect pollutant data in respect of a pollutant at a site;
   an audio and/or image data sensor configured to capture audio and/or image data at the site; and
   one or more computers configured to perform the method of any of clauses 1 to 22.

1. A computer implemented method of generating a pollution event report, the method comprising:
receiving pollutant data in respect of a pollutant measured at a site;
determining, based on the pollutant data, that a pollution event has occurred at the site;
receiving, based on the determination that a pollution event has occurred at the site, audio and/or image data captured at the site;
generating a pollution event report including an association between the pollution event and the audio and/or image data; and
sending, to a terminal, at least a portion of the pollution event report, the terminal being associated with a user associated with the site.

2. The method of claim 1, wherein a pollution event is determined to have occurred when the pollutant is measured to have breached a threshold level.

3. The method of claim 2, wherein the threshold level is based on at least one or more of the pollutant, the time of day, the day of the week, or the time in the year.

4. The method of claim 1, wherein the pollutant may be one or more of noise, light, carbon dioxide, carbon monoxide, one or more nitrous oxides, particulate matter; wherein optionally the particulate matter has diameters less than 10 μm, less than 4 μm, less than 2.5 μm, or less than 1 μm.

5. The method of claim 2, further comprising obtaining a baseline level of the pollutant; wherein the pollution event report includes a comparison of the baseline level of the pollutant with the measured pollutant level.

6. The method of claim 5, wherein the baseline level is a historic average for a corresponding time period to the time at which the pollution event is determined to occur; wherein optionally the corresponding time period is one or more of a time of day, a day of the week, and a day of the month.

7. The method of claim 1, wherein the pollution event lasts for a predetermined duration starting from when the pollution event is determined to have occurred; wherein further pollution events based on the same pollutant cannot occur within the predetermined duration; and wherein optionally the predetermined duration is 15 minutes, half an hour, one hour, or two hours.

8. The method of claim 7, wherein the pollution event retrospectively begins a predefined period before the pollution event is determined to have occurred; and wherein optionally the predetermined duration is 15 minutes, half an hour, one hour, or two hours.

9. The method of claim 7, wherein the predetermined duration and/or the predefined period is different for different pollutants.

10. The method of claim 1, wherein the audio and/or image data includes one or more of a photograph, a thermal image, an acoustic image, a video clip, and an audio clip; and/or
wherein the audio and/or image data is captured in response to the determination that a pollution event has occurred.

11. The method of claim 1, wherein the audio and/or image data is captured on a continuous basis and stored for a predetermined period of time after which it is deleted if no pollution event is determined to have occurred within the predetermined period of time; wherein optionally the predetermined period of time is 15 minutes, half an hour, or one hour.

12. The method of claim 1, comprising identifying, from the received audio and/or image data, one or more potential polluters;
wherein the pollution event reports includes the one or more identified potential polluters; and
wherein optionally the one or more potential polluters includes one or more vehicles, pieces of machinery, pieces of equipment, and people.

13. The method of claim 12, wherein the one or more potential polluters are identified using one or more of image recognition, such as automatic number plate recognition, audio recognition, and artificial intelligence.

14. The method of claim 1, further comprising:
prompting the user associated with the terminal to input, at the terminal, contextual information about the pollution event;
receiving the contextual information from the terminal; and
updating the pollution event report to include the contextual information.

15. The method of claim 1, wherein the terminal to which the at least a portion of the pollution event report is sent is one of a predefined list of terminals associated with a predefined list of users associated with the site.

16. The method of claim 15, wherein the terminal is selected from the predefined list of terminals such that it is a terminal associated with a user who is present at the site;
wherein optionally the user who is present at the site is determined based on one or more of: facial recognition performed on images taken from the site; a predefined schedule of users at the site; an electronic logbook of users at the site; and a detection of a terminal that is associated with the user at the site.

17. The method of claim 1, wherein the terminal is a mobile phone or device capable of receiving an SMS message, and wherein the at least a portion of the pollution event report is sent to the terminal as an SMS message.

18. The method of claim 1, wherein the at least a portion of the pollution event report comprises some or all of the audio and/or image data.

19. The method of claim 1, further comprising receiving environmental data corresponding to the time of the pollution event; wherein the pollution event report includes the environmental data; and
wherein optionally the method further comprises determining whether the environmental data was likely to have contributed to the pollution event or not; wherein the pollution event report includes the determination of whether the environmental data was likely to have contributed to the pollution event or not.

20. The method of claim 19, wherein the environmental data is environmental data reflective of a geographical region within which the site is located; wherein optionally the geographic region is an administrative region, a city, a borough, a county, a state, a post code area, or a ZIP code area.

21. The method of claim 19, wherein the environmental data includes weather data; wherein optionally the weather data includes one or more of wind speed and/or direction, precipitation type and/or amount, air quality, dust or particulate matter concentration.

22. The method of claim 1, further comprising determining a mitigation action based on the generated pollution event report.

23. A computer program that, when executed on one or more computers, causes the one or more computers to perform a method comprising:
receiving pollutant data in respect of a pollutant measured at a site;
determining, based on the pollutant data, that a pollution event has occurred at the site;
receiving, based on the determination that a pollution event has occurred at the site, audio and/or image data captured at the site,
generating a pollution event report including an association between the pollution event and the audio and/or image data; and
sending, to a terminal, at least a portion of the pollution event report, the terminal being associated with a user associated with the site.,

24. A non-transitory computer readable storage medium having stored thereon a computer program that, when executed on one or more computers, causes the one or more computers to perform a method comprising:
receiving pollutant data in respect of a pollutant measured at a site;
determining, based on the pollutant data, that a pollution event has occurred at the site,
receiving, based on the determination that a pollution event has occurred at the site, audio and/or image data captured at the site;
generating a pollution event report including an association between the pollution event and the audio and/or image data; and
sending, to a terminal, at least a portion of the pollution event report, the terminal being associated with a user associated with the site.

25. A system comprising:
a pollution sensor configured to collect pollutant data in respect of a pollutant at a site;
an audio and/or image data sensor configured to capture audio and/or image data at the site; and
one or more computers configured to perform a method comprising:
receiving pollutant data in respect of a pollutant measured at a site;
determining, based on the pollutant data, that a pollution event has occurred at the site;
receiving, based on the determination that a pollution event has occurred at the site, audio and/or image data captured at the site,
generating a pollution event report including an association between the pollution event and the audio and/or image data; and
sending, to a terminal, at least a portion of the pollution vent report, the terminal being associated with the site.
